(19) United States
(12) Patent Application Publication
(10) Pub. No.: US 2026/0124547 A1
(43) Pub. Date: May 7, 2026

(54) SERVER, ELECTRONIC DEVICE AND GAME VIDEO PROCESSING METHOD THEREOF

(71) Applicant: Acer Incorporated, New Taipei City (TW)

(72) Inventor: Yao-Ting HUANG, New Taipei City (TW)

(73) Assignee: Acer Incorporated, New Taipei City (TW)

(21) Appl. No.: 19/331,560

(22) Filed: Sep. 17, 2025

(30) Foreign Application Priority Data
Nov. 1, 2024 (TW) 113141840

(51) Int. Cl. A63F 13/73; A63F 13/77; A63F 13/86

(52) U.S. Cl. CPC A63F 13/73; A63F 13/77; A63F 13/86

(57) ABSTRACT

A server, an electronic device and a game video processing method thereof are provided. The game video processing method includes the following steps. A game video is recorded and a plurality of game events in the game video are recorded. The game events of the game video are edited into a game history. The game history and a related information of the game video are stored as a video information. An anti-counterfeiting label for the game video and the video information is created. Whether the game video meets at least one filtering condition is determined according to a filtering profile. If the game video meets the at least one filtering condition, whether the electronic device obtains a video upload permission token is determined. If the electronic device obtains the video upload permission token, the game video, the video information and the anti-counterfeiting label are uploaded to the server.

This application claims the benefit of Taiwan application Serial No. 113141840, filed November 1, 2024, the disclosure of which is incorporated by reference herein in its entirety.

### TECHNICAL FIELD

The disclosure relates in general to an electronic device and a process method thereof, and more particularly to a server, an electronic device and a game video processing method thereof.

### BACKGROUND

When the server provides space for gamers to upload game videos for others to watch or download, there are often some problems. For example, too many uploads consume bandwidth, too much server storage space is occupied, the uploaded game videos are too empty, the game videos are altered or violate good customs or laws, etc., which require huge costs to analyze and review.

Therefore, if we can automatically filter out the game videos that meet the conditions and upload them to the server, and set conditions to control the number of videos uploaded to the server, we can greatly reduce costs and manpower, and ensure the accuracy of the uploaded content.

### SUMMARY

The present disclosure is related to a server, an electronic device and a game video processing method thereof, which utilizes the analysis of game events in game videos to filter out game videos that meet the conditions. In addition, an anti-counterfeiting label is used to prevent the uploaded game videos and video information from being tampered with, thereby ensuring the accuracy of the uploaded content. In addition, the screening conditions and setting conditions could be adjusted at any time to control the number of videos uploaded to the server.

According to one embodiment, a game video processing method of an electronic device is provided. The game video processing method of an electronic device includes the following steps. A game video is recorded and a plurality of game events in the game video are recorded. The game events of the game video are edited into a game history. The game history and a related information of the game video are stored as a video information. An anti-counterfeiting label for the game video and the video information is created. Whether the game video meets at least one filtering condition is determined according to a filtering profile. If the game video meets the at least one filtering condition, whether the electronic device obtains a video upload permission token is determined. If the electronic device obtains the video upload permission token, the game video, the video information and the anti-counterfeiting label are uploaded to the server.

According to another embodiment, a game video processing method of a server. The game video processing method of the server includes the following steps. A video upload request is received. Whether an electronic device has obtained a video upload permission token is determined. The electronic device is allowed to upload a game video and a video information, if the electronic device obtains the video upload permission token. Analysis is performed according to the video information. An analyzing result of the video information is stored. A filtering profile is updated according to the analyzing result.

According to an alternative embodiment, an electronic device. The electronic device includes a streaming unit, a data processing unit, a storage unit and a controlling unit. The streaming unit includes a video recording element. The video recording element is used for recording a game video. The data processing unit includes a game event listening element and a game history processing element. The game event listening element is used for recording a plurality of game events in the game video. The game history processing element is used for editing the game events of the game video into a game history. The storage unit includes a game video storage area and a video information storage area. The game video storage area is used for storing the game video. The video information storage area is used for storing the game history and a related information of the game video as a video information. The controlling unit includes an anti-counterfeiting processing element, a filter profile downloading element, a video filtering element and a video uploading element. The anti-counterfeiting processing element is used for creating an anti-counterfeiting label for the game video and the video information. The filter profile downloading element is used for downloading a filtering profile. The video filtering element is used for determining whether the game video meets at least one filtering condition according to the filtering profile. If the game video meets the at least one screening condition, the video uploading element determines whether the electronic device has obtained a video upload permission token. If the electronic device obtains the video upload permission token, the video uploading element uploads the game video, the video information and the anti-counterfeiting label to a server.

### BRIEF DESCRIPTION OF THE DRAWINGS

FIG. 1 illustrates an example of a game video of an electronic device.

FIG. 2 shows a block diagram of an electronic device and a server according to an embodiment of the present disclosure.

FIG. 3 illustrates a flow chart of a game video processing method of an electronic device according to an embodiment of the present disclosure.

FIG. 4 is a flowchart of a game video processing method of the server according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

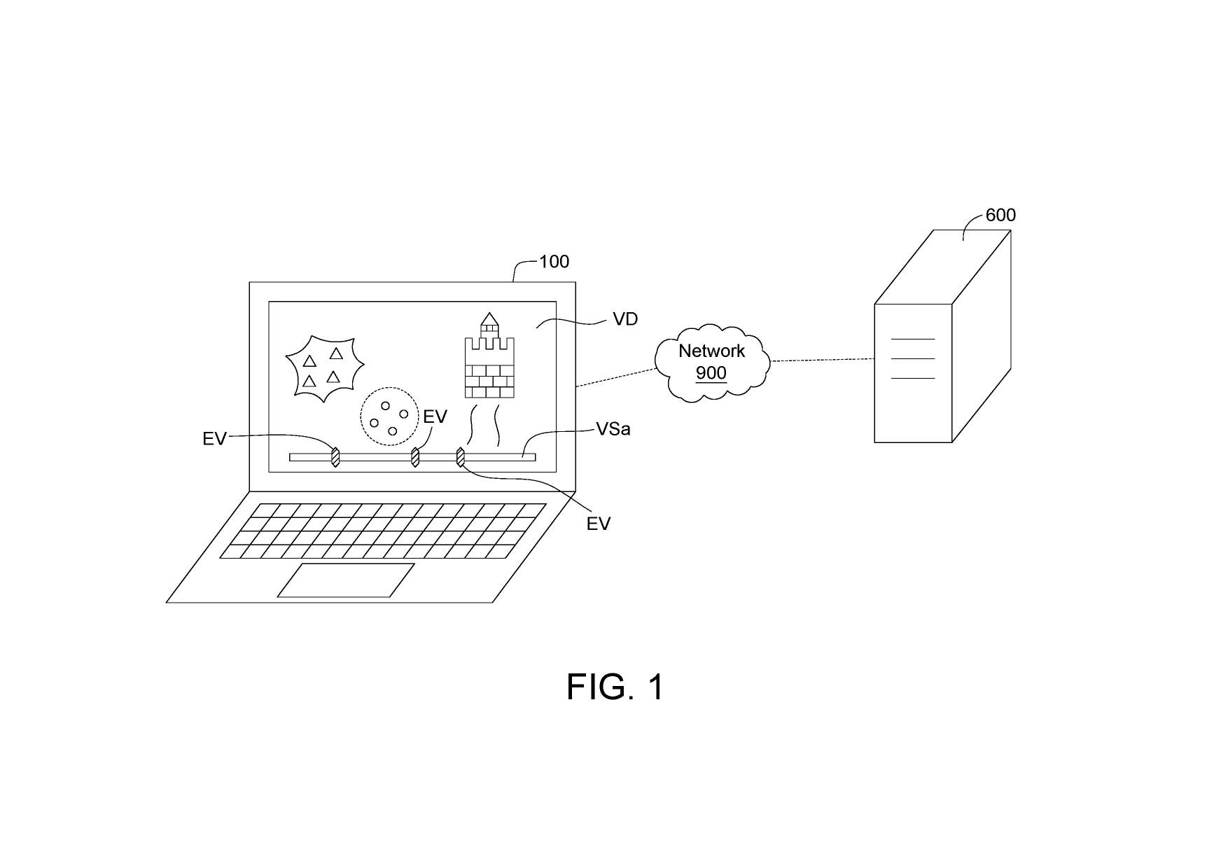

Please refer to FIG. 1, which illustrates an example of a game video VD of an electronic device 100. In one embodiment, a user records a game process into a game video VD. The game video VD includes special game event EVs, such as killing an enemy, continuous firing, or using a special skill. The user transmits the game video VD with the game event EVs via a network 900 and stores it in a server 600, so that other users could download and watch it.

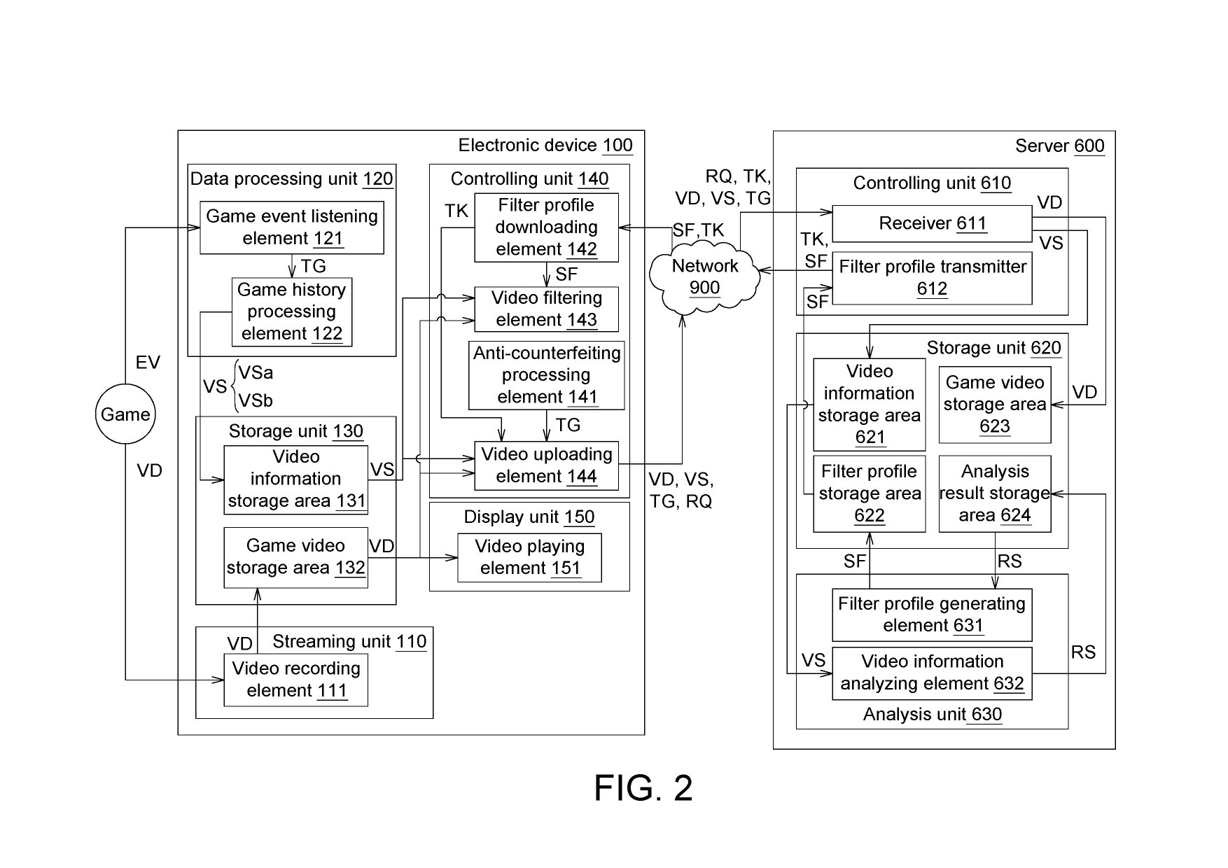

Please refer to FIG. 2, which shows a block diagram of an electronic device 100 and a server 600 according to an embodiment of the present disclosure. The electronic device 100 includes a streaming unit 110, a data processing unit 120, a storage unit 130, a controlling unit 140 and a display unit 150. The streaming unit 110 includes a video recording element 111. The data processing unit 120 includes a game event listening element 121 and a game history processing element 122. The storage unit 130 includes a video information storage area 131 and a game video storage area 132. The controlling unit 140 includes an anti-counterfeiting processing element 141, a filter profile downloading element 142, a video filtering element 143 and a video uploading element 144. The display unit 150 includes a video playing element 151.

The server 600 includes a controlling unit 610, a storage unit 620 and an analysis unit 630. The controlling unit 610 includes a receiver 611 and a filter profile transmitter 612. The storage unit 620 includes a video information storage area 621, a filter profile storage area 622, a game video storage area 623 and an analysis result storage area 624. The analysis unit 630 includes a filter profile generating element 631 and a video information analyzing element 632.

The streaming unit 110 is used to process and intercept the stream. The data processing unit 120 is used to analyze and organize the data. The controlling unit 140 and the controlling unit 610 are used to establish, filter, set, and control. The analysis unit 630 is used to analyze and filter. The streaming unit 110, the data processing unit 120, the controlling unit 140, the controlling unit 610 and/or the analysis unit 630 is, for example, a circuit, a circuit board, a storage device for storing program codes, or a chip. The chip is, for example, a central processing unit (CPU), a programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), an embedded system, a field programmable gate array (FPGA), other similar element or a combination thereof.

The storage unit 130 and the storage unit 620 are used to store various data, such as any type of fixed or removable random access memory (RAM), read-only memory (ROM), flash memory, hard disk drive (HDD), solid state drive (SSD) or similar elements or a combination of the above elements, and are used to store multiple modules or various application programs that can be executed by the processor.

In this embodiment, the analysis of the game video VD is used to filter out the game video VD that meets the conditions. In addition, the anti-counterfeiting label TG is used to prevent the uploaded content from being altered and tampered, thereby ensuring the correctness of the uploaded content. In addition, the screening conditions and setting conditions can be adjusted at any time to control the number of videos uploaded to the server 600. The following flowchart is used to describe in detail the operation of the above-mentioned components.

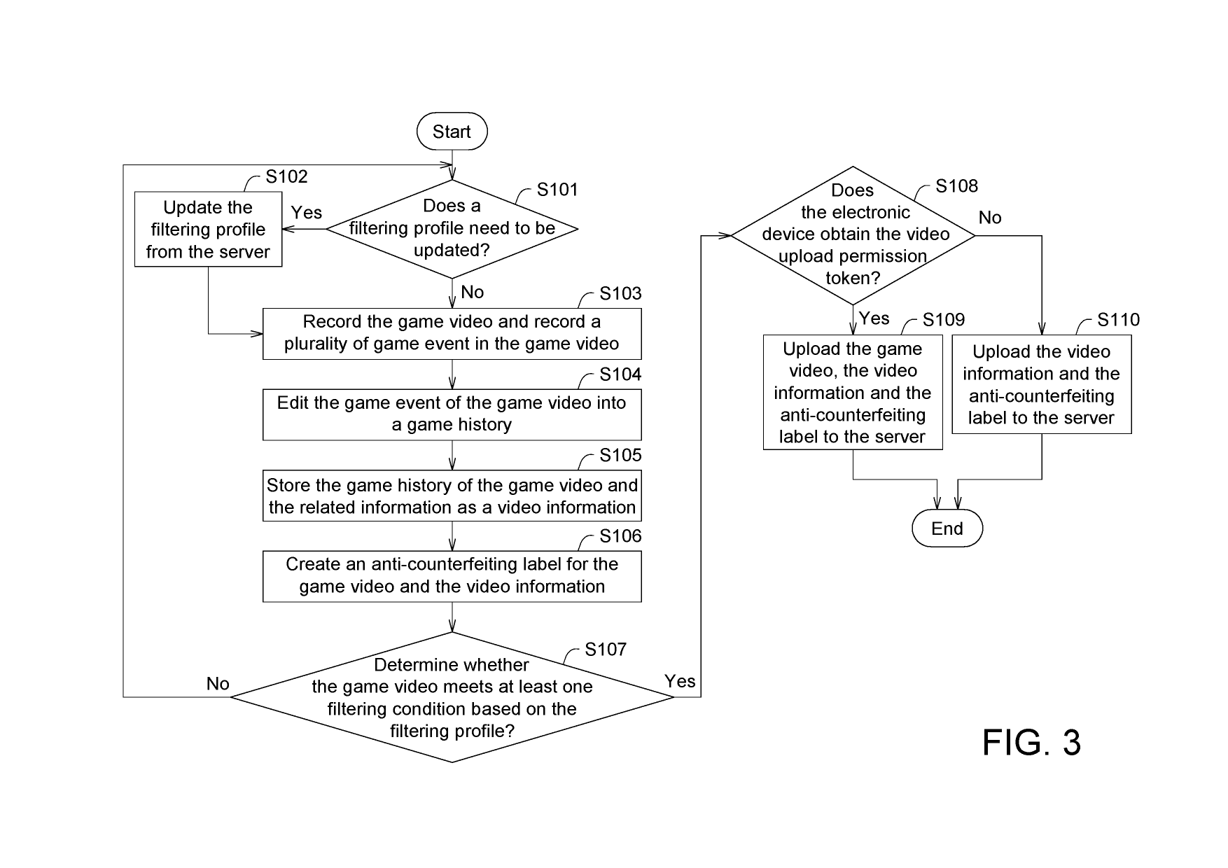

Please refer to FIG. 3, which illustrates a flow chart of a game video processing method of an electronic device 100 according to an embodiment of the present disclosure. The game video processing method of the electronic device 100 includes steps S101 to S110.

In the step S101, as shown in FIG. 2, the filter profile downloading element 142 of the controlling unit 140 checks whether a filtering profile SF needs to be updated. If the filtering profile SF needs to be updated, the process proceeds to the step S102; if the filtering profile SF does not need to be updated, the process proceeds to the step S103.

In the step S102, as shown in FIG. 2, the filter profile downloading element 142 of the controlling unit 140 updates the filtering profile SF from the server 600. When the filtering profile SF has an updated version, the filter profile downloading element 142 sends a request to the server 600 to obtain the new version of the filtering profile SF from the filter profile storage area 622 of the server 600.

In the step S103, as shown in FIG. 2, the video recording element 111 of the streaming unit 110 records the game video VD, and the game event listening element 121 of the data processing unit 120 records a plurality of game event EVs in the game video VD. As shown in FIG. 1, the game video VD is a continuous video, and the game event EV is a single time point event or a segment video event in the continuous video.

Next, in the step S104, as shown in FIG. 1 and FIG. 2, the game history processing element 122 of the data processing unit 120 edits the game event EV of the game video VD into a game history VSa. There may be multiple game event EVs in the game video VD, for example, event 1: 180 seconds, player character P, kills, enemy character X; event 2: 240 seconds, player character P, dies; event 3: 300 seconds, player character P, kills, enemy character Y. The game history processing element 122 edits the game event EV of the game video VD according to time to assemble into a game history VSa.

Then, in the step S105, as shown in FIG. 2, the video information storage area 131 of the storage unit 130 stores the game history VSa of the game video VD and the related information VSb as a video information VS. The related information VSb of the game video VD includes, for example, the player's country, time zone, game name, game type, game character, play date, play device information, and the like.

Next, in the step S106, as shown in FIG. 2, the anti-counterfeiting processing element 141 of the controlling unit 140 creates an anti-counterfeiting label TG for the game video VD and the video information VS. The anti-counterfeiting label TG is created through an MD5 Message-Digest algorithm or a secure hash algorithm (SHA). The anti-counterfeiting label TG could prevent the game video VD and the video information VS from being tampered with when they are uploaded.

Then, in the step S107, as shown in FIG. 2, the video filtering element 143 of the controlling unit 140 determines whether the game video VD meets at least one filtering condition based on the filtering profile SF. If the game video VD meets the filtering condition, the step S108 is entered. The filtering condition is, for example, "Taiwanese players achieve 5 consecutive kills within 30 seconds in League of Legends". According to this filtering condition, the video filtering element 143 will find the country of "Taiwan", the game type is "League of Legends", and the game history VSa of the video information VS has a record of "continuously killing 5 enemy players within 30 seconds".

Next, in the step S108, as shown in FIG. 2, the video uploading element 144 determines whether the electronic device 100 obtains the video upload permission token TK. If the electronic device 100 obtains the video upload permission token TK, the process proceeds to the step S109; if the electronic device 100 does not obtain the video upload permission token TK, the process proceeds to the step S110. The video upload permission token TK is used to limit the number of game video VD uploads. The server 600 will issue a certain number of video upload permission tokens TK, and the electronic device 100 that does not obtain the video upload permission token TK will not be able to upload game video VD.

In the step S109, as shown in FIG. 2, the video uploading element 144 uploads the game video VD, the video information VS and the anti-counterfeiting label TG to the server 600.

In the step S110, as shown in FIG. 2, the video uploading element 144 uploads the video information VS and the anti-counterfeiting label TG to the server 600. The electronic device 100 that has not obtained the video upload permission token TK could only upload the video information VS and the anti-counterfeiting label TG. The video information VS could be used by the server 600 for information statistics and analysis.

By using the game video processing method of the electronic device 100 of the above embodiment, the electronic device 100 could automatically filter out the game video VD that meets the filtering profile SF and upload it to the server 600. The filtered game video VD has a certain representativeness and does not occupy too much storage space.

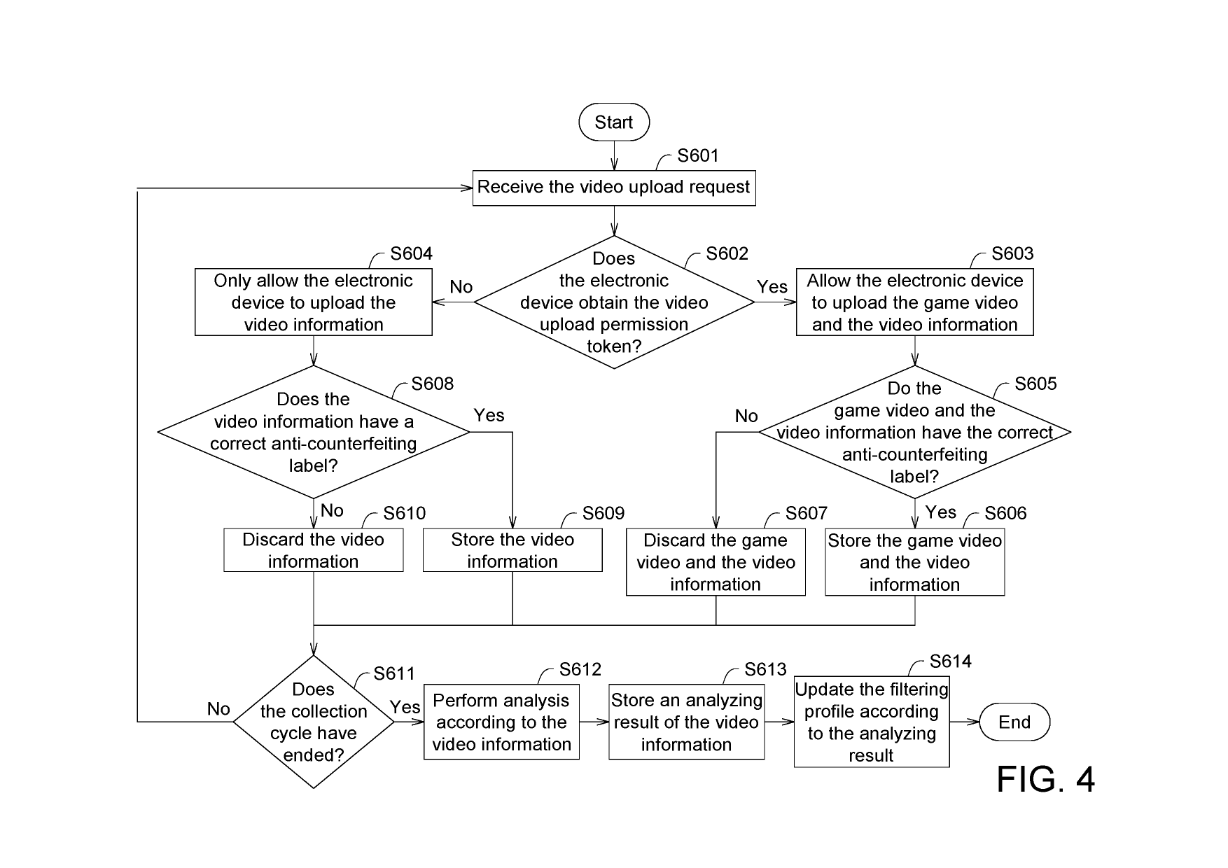

On the other hand, the server 600 also has a corresponding design. Please refer to FIG. 2 and FIG. 4. FIG. 4 is a flowchart of a game video processing method of the server 600 according to an embodiment of the present disclosure. The game video processing method of the server 600 includes step S601 to step S614.

In the step S601, as shown in FIG. 2, the receiver 611 of the controlling unit 610 receives the video upload request RQ.

Next, in the step S602, as shown in FIG. 2, the receiver 611 of the controlling unit 610 determines whether the electronic device 100 obtains the video upload permission token TK. If the electronic device 100 obtains the video upload permission token TK, the process proceeds to the step S603; if the electronic device 100 does not obtain the video upload permission token TK, the process proceeds to the step S604. The number of issued video upload permission tokens TK is the number of game video VDs to be collected, and only the electronic device 100 that obtains the video upload permission token TK could upload game video VDs.

In the step S603, as shown in FIG. 2, the receiver 611 of the controlling unit 610 allows the electronic device 100 to upload the game video VD and the video information VS.

Next, in the step S605, as shown in FIG. 2, the receiver 611 of the controlling unit 610 determines whether the game video VD and the video information VS have the correct anti-counterfeiting label TG. If the game video VD and the video information VS have the correct anti-counterfeiting label TG, the process proceeds to the step S606; if the game video VD and the video information VS do not have the correct anti-counterfeiting label TG, the process proceeds to the step S607.

In the step S606, as shown in FIG. 2, the receiver 611 of the controlling unit 610 stores the game video VD and the video information VS in the game video storage area 623 and the video information storage area 621 of the controlling unit 610.

In the step S607, as shown in FIG. 2, the receiver 611 of the controlling unit 610 discards the game video VD and the video information VS. The receiver 611 of the controlling unit 610 decodes and compares the anti-counterfeiting label TG. If the anti-counterfeiting label TG is incorrect, it means that the uploaded content has been tampered with, so the uploaded content must be discarded.

In the step S604, as shown in FIG. 2, the receiver 611 of the controlling unit 610 only allows the electronic device 100 to upload the video information VS, and does not allow the electronic device 100 to upload the game video VD.

Next, in the step S608, as shown in FIG. 2, the receiver 611 of the controlling unit 610 determines whether the video information VS has a correct anti-counterfeiting label TG. If the video information VS has a correct anti-counterfeiting label TG, the process proceeds to the step S609; if the video information VS does not have a correct anti-counterfeiting label TG, the process proceeds to the step S610.

In the step S609, as shown in FIG. 2, the receiver 611 of the controlling unit 610 stores the video information VS to the video information storage area 621 of the storage unit 620.

In the step S610, the receiver 611 of the controlling unit 610 discards the video information VS. The receiver 611 of the controlling unit 610 decodes and compares the anti-counterfeiting label TG. If the anti-counterfeiting label TG is incorrect, it means that the uploaded content has been tampered with, so the uploaded content must be discarded.

Next, in the step S611, as shown in FIG. 4, whether the collection cycle has ended is determine. If the collection cycle has ended, the process proceeds to the step S612; if the collection cycle has not ended, the process returns to the step S601. The server collection cycle is, for example, one day, one week, or one month. If the collection cycle has not ended, it is necessary to repeat the above steps S601 to S610 to continuously collect the game video VD and, the video information VS.

In the step S612, as shown in FIG. 2, the video information analyzing element 632 of the analysis unit 630 performs analysis according to the video information VS.

When the collection cycle is over, the video information analyzing element 632 will start to statistically analyze the video information VS obtained in this collection cycle.

Then, in the step S613, the video information analyzing element 632 of the analysis unit 630 stores an analyzing result RS of the video information VS in the analysis result storage area 624 of the storage unit 620.

Next, in the step S614, the filter profile generating element 631 of the analysis unit 630 updates the filtering profile SF according to the analyzing result RS.

For example, when the collection achievement rate in the analyzing result RS is too low, it means that the screening conditions are too strict and not conducive to collection, and the screening conditions need to be adjusted. Or, the analyzing result RS shows that a certain game event EV is over-concentrated, and the screening conditions need to be adjusted. Or when the purpose of collection is exciting battles, it is too easy to achieve, which means that the battle content is objectively not exciting enough.

In addition, if the proportion of the details of the filtering items is too low or too high, it will affect the diversity of the collected game video VDs and cause problems. For example, a large number of players in a certain region use plug-ins, and the winning rate is abnormally high, which meets the filtering conditions, resulting in the uploaded game video VDs being all provided by players in a certain region, or the game manufacturer suddenly updates the game settings and strengthens a certain character in the game, making it easier for the character to produce wonderful performances and meet the filtering conditions, resulting in the uploaded game video VDs being almost all the game content of this game character. Therefore, it is necessary to generate the filtering profile SF for the next collection cycle at any time based on the analyzing result RS. The automatically generated filtering profile SF can also be adjusted by the user.

For example, if the achievement rate is too low, the difficulty of the screening conditions will be reduced, such as from 5 consecutive kills in 30 seconds to 3 consecutive kills; if the achievement rate is too high, the difficulty of the screening conditions will be increased, such as from simply winning to the game character that cannot have a death record in the entire game and win the final victory.

Or, when the proportion of a certain statistical item is too low, add a new filter condition to only allow the upload of video information VS game video VD that meets this detail, for example, there are too few game video VDs from the United States, so only game video VDs from the United States are allowed to be uploaded in the next round; when the proportion of a certain statistical item is too high, add a new filter condition to not allow the upload of video information VS game video VD that meets this detail, for example, there are too many game video VDs of a certain game character, so the next round will not allow the upload of game video VDs using this game character.

According to the game video processing method of the server 600, the mechanism of issuing the video upload permission token TK could effectively control the network bandwidth and storage space consumption of the server 600. And through the confirmation of the anti-counterfeiting label TG, the uploaded game video VD and the video information VS could be prevented from being tampered with, ensuring the correctness of the uploaded content. By adjusting the filtering profile SF in a rolling manner through multiple collection cycles, the collected game video VD could be prevented from being too monotonous, and the update method of game settings by cheat players and game manufacturers could be responded to in real time. The settings could be more localized and customized, and different filtering conditions could be set for different regions and different games.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A game video processing method of an electronic device, comprising:
recording a game video and recording a plurality of game events in the game video;
editing the game events of the game video into a game history;
storing the game history and a related information of the game video as a video information;
creating an anti-counterfeiting label for the game video and the video information;
determining whether the game video meets at least one filtering condition according to a filtering profile;
determining whether the electronic device obtains a video upload permission token, if the game video meets the at least one filtering condition; and
uploading the game video, the video information and the anti-counterfeiting label to a server, if the electronic device obtains the video upload permission token.

2. The game video processing method of the electronic device according to claim 1, further comprising:
checking whether the filtering profile needs to be updated; and
updating the filtering profile from the server, if the filtering profile needs to be updated.

3. The game video processing method of the electronic device according to claim 1, further comprising:
uploading the video information and the anti-counterfeiting label to the server, if the electronic device does not obtain the video upload permission token.

4. The game video processing method of the electronic device according to claim 1, wherein the video information includes country, time zone, game name, game type, game character, game date or game device.

5. The game video processing method of the electronic device according to claim 1, wherein the anti-counterfeiting label is created using an MD5 message-digest algorithm or a secure hash algorithm (SHA).

6. The game video processing method of the electronic device according to claim 1, wherein the game events in the game video are edited according to time to form the game history.

7. The game video processing method of the electronic device according to claim 1, wherein the game event is a single point in time event or a fragment of video in a continuous video.

8. A game video processing method of a server, comprising:
receiving a video upload request;
determining whether an electronic device has obtained a video upload permission token;
allowing the electronic device to upload a game video and a video information, if the electronic device obtains the video upload permission token;
performing analysis according to the video information;
storing an analyzing result of the video information; and
updating a filtering profile according to the analyzing result.

9. The game video processing method of the server according to claim 8, further comprising:
determining whether the game video and the video information have an anti-counterfeiting label which is correct;
storing the game video and the video information, if the game video and the video information have the anti-counterfeiting label which is correct; and
discarding the game video and the video information, if the game video and the video information do not have the anti-counterfeiting label which is correct.

10. The game video processing method of the server according to claim 8, further comprising:
only allowing the electronic device to upload the video information, if the electronic device does not obtain the video upload permission token.

11. The game video processing method of the server according to claim 10, further comprising:
determining whether the video information has an anti-counterfeiting label which is correct;
storing the video information, if the video information has the anti-counterfeiting label which is correct; and
discarding the video information, if the video information does not have the anti-counterfeiting label which is correct.

12. The game video processing method of the server according to claim 8, wherein the video information includes country, time zone, game name, game type, game character, game date or game device.

13. The game video processing method of the server according to claim 8, wherein the anti-counterfeiting label is created using an MD5 message-digest algorithm or a secure hash algorithm (SHA).

14. The game video processing method of the server according to claim 8, wherein the game events in the game video are edited according to time to form the game history.

15. An electronic device, comprising:
a streaming unit, comprising:
a video recording element, used for recording a game video;
a data processing unit, comprising:
a game event listening element, used for recording a plurality of game events in the game video; and
a game history processing element, used for editing the game events of the game video into a game history;
a storage unit, comprising:
a game video storage area, used for storing the game video; and
a video information storage area, used for storing the game history and a related information of the game video as a video information; and
a controlling unit, comprising:
an anti-counterfeiting processing element, used for creating an anti-counterfeiting label for the game video and the video information;
a filter profile downloading element, used for downloading a filtering profile;
a video filtering element, used for determining whether the game video meets at least one filtering condition according to the filtering profile; and
a video uploading element, wherein if the game video meets the at least one screening condition, the video uploading element determines whether the electronic device has obtained a video upload permission token; if the electronic device obtains the video upload permission token, the video uploading element uploads the game video, the video information and the anti-counterfeiting label to a server.

16. The electronic device according to claim 15, wherein the filter profile downloading element is also used to check whether the filtering profile needs to be updated; if the filtering profile needs to be updated, the filter profile downloading element updates the filtering profile from the server.

17. The electronic device according to claim 15, wherein if the electronic device does not obtain the video upload permission token, the video uploading element uploads the video information and the anti-counterfeiting label to the server.

18. The electronic device according to claim 15, wherein the video information includes country, time zone, game name, game type, game character, game date or game device.

19. The electronic device according to claim 15, wherein the anti-counterfeiting label is created using an MD5 message-digest algorithm or a secure hash algorithm (SHA).

20. The electronic device according to claim 15, wherein the game events in the game video are edited according to time to form the game history.
* * * * *
